(19) United States
(12) Patent Application Publication
(10) Pub. No.: US 2014/0122451 A1
(43) Pub. Date: May 1, 2014

(54) SYSTEM AND METHOD FOR PREVENTING DUPLICATE FILE UPLOADS FROM A MOBILE DEVICE

(71) Applicant: DROPBOX, INC., San Francisco, CA (US)

(72) Inventors: David Euresti, San Francisco, CA (US); Brian Smith, San Francisco, CA (US); Alicia Chen, San Francisco, CA (US); Alex Sydell, San Francisco, CA (US); Aston Motes, San Francisco, CA (US); Jie Tang, San Francisco, CA (US); Rian Hunter, San Francisco, CA (US)

(73) Assignee: DROPBOX, INC., San Francisco, CA (US)

(21) Appl. No.: 13/724,643

(22) Filed: Dec. 21, 2012

Related U.S. Application Data
(60) Provisional application No. 61/719,734, filed on Oct. 29, 2012.

(51) Int. Cl. G06F 17/30

(52) U.S. Cl. CPC G06F 17/3015
USPC 707/693

(57) ABSTRACT

A method and system for preventing duplicate file uploads in a remote content management system is described. The user device receives a hash value list associated with the files stored in the remote content management system. The user device calculates a hash value associated with new files to be uploaded. The system then compares the hash value(s) associated with the new file(s) to be uploaded with the hash value list received from the remote file storage system. If the hash values of any of the new files to be uploaded match a hash value on the hash value list, then the system prevents the new files from being uploaded to the remote file storage system.

### CLAIM OF PRIORITY

This claims the benefit of priority under 35 U.S.C. §119(e) to U.S. Provisional Patent Application No. 61/719,734, filed Oct. 29, 2012, entitled, “System and Method for Preventing Duplicate Photo Uploads in a Synchronized File Management System,” which is incorporated herein by reference in its entirety.

### BACKGROUND

Today, a large percentage of electronic content management, storage, and related services are remote, or “cloud” based. That is, many services allow a user to upload, store, and share files through remote servers. The trend is to centralize files (e.g., photos) and allow a user to access these centrally stored files through multiple devices and/or locations, utilizing a single account. Centralized storage is especially useful for two reasons. First, mobile devices, such as smart phones, tablets, and cameras, may have limited storage space. Second, users may desire to access all of their files (e.g., photos or videos) at any time on any device; however, it is impractical to store copies of all photo or video files on all devices.

When the user has multiple devices that are configured to allow for automatic uploads, the system may upload the same file twice. In a particular example, a user may take a photo on their smart phone, which is configured to automatically upload the photo to a cloud-based content management system. Later, the user may save the same photo to their desktop computer when they dock their smart phone with their computer. The computer may be set up to upload image files from the smart phone and may also be configured to act as a client device with the content management system. In this instance, the photo may be automatically uploaded twice—once directly from the smart phone and again from the desktop computer. Detecting duplicate uploads may further be frustrated since the first uploaded image file may have been renamed when it was uploaded to the computer from the smart phone. As illustrated from this example, uploading a duplicate photo is inefficient, wastes bandwidth (especially in the case of mobile devices), creates electronic clutter, and takes up unnecessary space on the content management system's servers. The present disclosure recognizes and addresses the foregoing considerations, and others, of prior art system and methods.

### SUMMARY

A computer-implemented method, according to various embodiments, may provide a content management system that prevents the upload of duplicate files. In various embodiments, the method may include receiving a hash value list including a hash value for at least one file (e.g. an image file) stored in the cloud-based storage location. In various embodiments, the method may also include calculating, on the client device, a hash value for the file stored on the client device. Also, in various embodiments, the method may include searching the hash value list for the calculated hash value; and enabling an upload of the file from the client device to the cloud-based storage location, or preventing an upload of the file if the calculated hash value for the file is found in the received hash value list. In various embodiments, the hash value may be calculated using a MD5 checksum algorithm. In some embodiments, the client device may be a mobile device.

In various embodiments, the hash value may be calculated based on at least one attribute and a portion of the data associated with the file. In some of these embodiments, the attribute of the file may be the size of the file. Also, in various embodiments, the first 8 kilobytes of data of the file may be used to calculate the hash value. In various embodiments, the step of enabling the upload of the file from the client device may further include uploading the file and the hash value to a content management server associated with a cloud-based storage location or a content synchronization and file sharing system.

A computer system, according to various embodiments, may include a processor, memory operatively coupled to the processor, and a network connection operatively coupled to the processor. In various embodiments, the processor may be configured to receive a file containing a hash value list for one or more files (e.g., image files) stored in a user's account on the content management system. The processor may also be configured to calculate a hash value for each file stored in the memory. In various embodiments, the processor may determine if the calculated hash value for the file is included in the received file containing the hash value list and enable an upload, over the network connection, of the file if the calculated hash value for the file is not included in the hash value list.

A content management system that is linked to a client device may include: (1) receiving a file containing a hash value list for a plurality of files associated with an account stored in a cloud-based storage location (2) calculating a hash value for each file on the client device; (3) determining whether the calculated hash value for each file is contained in the hash value list; and (4) enabling an upload of each file where the calculated hash value for a file is not contained in the hash value list.

### BRIEF DESCRIPTION OF THE DRAWINGS

Various embodiments of a computer system for uploading and preventing duplicate copies of files from being uploaded from multiple devices are described below. In the course of this description, references will be made to the accompanying drawings, which are not necessarily drawn to scale, and wherein:

FIG. 1 shows a block diagram of a contact management system in accordance with an embodiment of the present system;

FIG. 2 shows a block diagram of a computer that may be used, for example, as a client device or server computer within the context of the content management system of FIG. 1; and

FIG. 3 shows a flow diagram that generally illustrates various steps executed by a client device in accordance with various embodiments of the system of FIG. 1.

### DETAILED DESCRIPTION

Various embodiments will now be described. It should be understood that the present systems and methods may be embodied in many different forms and should not be construed as limited to the embodiments set forth herein. Like numbers refer to like elements throughout.

### System Overview

A computer system according to various embodiments may include a content management system that receives automatically uploaded files from a client device (e.g., a desktop computer, a laptop computer, a handheld device, or other computing device) to a cloud-based storage location. In order to prevent duplicate files from being uploaded to the server (the content management system may calculate a hash value based on information related to the file. This information may include, for example, the size of the file, the file name, the content of the file, and/or any other suitable information.

In various embodiments, the system may compile a list that includes a hash value for each file that has been previously uploaded to the user's account. The system may use this list to prevent duplicate uploads from a mobile client device or desktop computer. On a mobile device, a hash value based on a small amount of information for a particular photo may be calculated and compared to the list. On a desktop computer, a hash value based on a more complete set of information for a particular photo may be calculated and compared to the list.

In either case, if the new file's hash value matches a hash value on the compiled list, then the system may automatically prevent an upload of the file to the server since the file is considered a duplicate of a previously uploaded file. If the new file's hash value does not match any of the values on the compiled list, then the client device may upload the new file to the server. In some cases, the server may use more sophisticated similar hash value comparison techniques to further verify that the uploaded file is not a duplicate of another file on the system.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

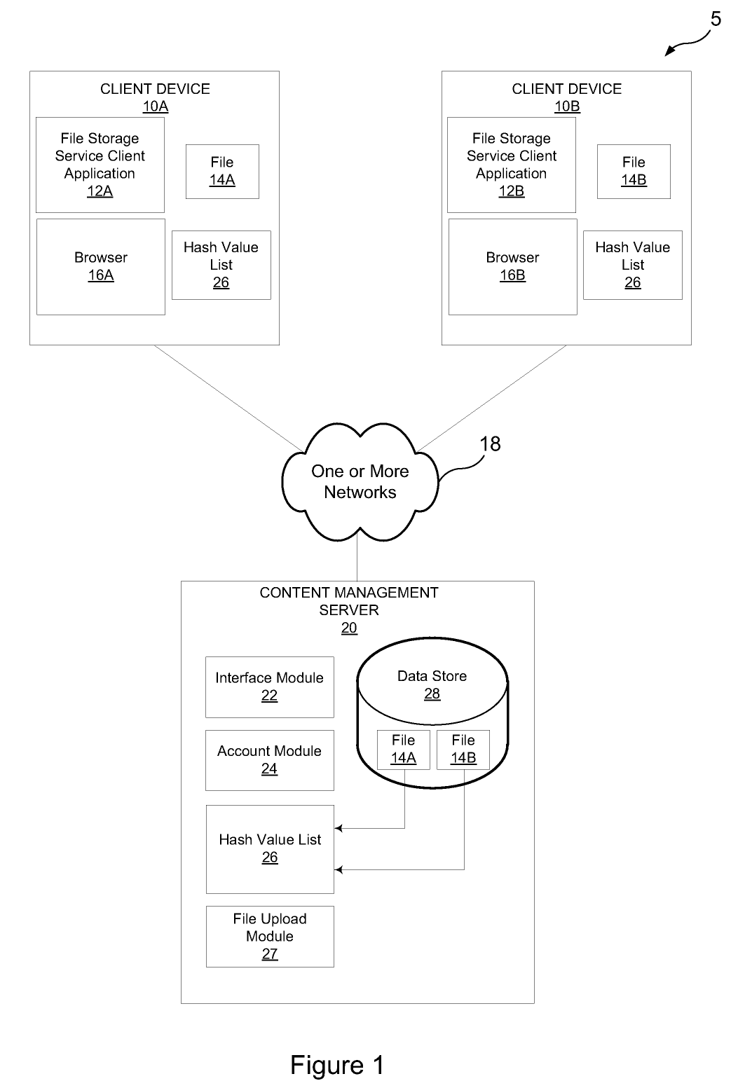

FIG. 1 is a block diagram of content management system 5 according to a particular embodiment. Content management system 5 includes one or more client devices 10A or 10B (collectively “10”), such as a desktop computer, a mobile device (e.g., a laptop computer, a smart phone, a mobile computing device, or a handheld device) or another device capable of transferring files over network 18, that are in communication with content management server 20. Network 18, between content management server 20 and client devices 10, may be, for example, implemented via one or more wired or wireless networks such as LANs, WANs, a cellular network, a Wi-Fi network, or via the Internet. For purposes of ease of explanation and clarity, no specific cellular network is shown in FIG. 1 as a network for a mobile device. However, a cellular tower may be coupled to a cellular network provider, which may be operatively coupled to network 18.

In some embodiments, content management server 20 includes data storage 28, interface module 22, account module 24, and file upload module 27. Content management server 20 is connected to one or more client devices 10 via network 18. In various embodiments, content management server 20 may include one or more servers that are located in close physical proximity, or some servers may be locally together and others remote. In either case, all devices, wherever located, function as a system.

Interface module 22 facilitates file access and file storage between content management server 20 and client devices 10. Interface module 22 receives files from and sends files to client devices 10 consistent with the user's preferences for sharing files. Interface module 22 may act as the counterpart to a client-side file storage service client application 12A, 12B user interface that allows a user to manipulate files directly stored on content management server 20. In some embodiments, software operating on client devices 10 integrates network-stored files with the client's local file system to enable a user to manipulate network-stored files through the same user interface (UI) used to manipulate files on the local file system, e.g., via a file explorer, file finder, or browser application. As an alternative or supplement to the client-side file explorer interface, user interface module 22 may provide a web interface for client devices 10 to access (e.g. via browser 16) and allow a user to manipulate files stored on content management server 20. In this way, the user can directly manipulate files stored on content management server 20.

In various embodiments, data store 28 stores files such as those uploaded using client devices 10. It should be understood that, in various embodiments, data store 28 may include of multiple data stores—some local to, and some remote from, content management server 20. In the embodiment illustrated in FIG. 1, a first user associated with client 10A has certain files 14A associated with their account, and a second user associated with client 10B has certain files 14B associated with their account. Copies of these files are centrally stored in data store 28. Copies of each respective user's files may also be locally stored on multiple client devices 10 associated with the user's account. In various embodiments, each client device 10A and 10B may be used by the same user. In these embodiments, each client device 10 may have files stored on content management server 20 that are synced across the client devices. In other embodiments, the client devices may be used by different users.

Data store 28 maintains, for each user in a file journal, information identifying the user, information describing the user's file directory, etc. In some embodiments, the file journal is maintained on content management server 20. This file journal may be updated periodically using information obtained directly from content management server 20 and/or from information obtained from one or more client devices 10 linked to the user's account. In this way, the server-stored file journal (hereinafter the “server-side file journal”) is updated when a file is changed either on the server or on one of the client devices associated with the user's account. When a file is changed, content management server 20 propagates the change to each client device associated with the user's account. For example, if a user makes a change to a particular file on a first client device, the change may be reflected in the server-side file journal. The system then uses the server-side file journal to propagate the change to all client devices associated with the user's account. Such techniques may be implemented, for example, within the context of a synchronized file system such as the Dropbox™ Service of Dropbox, Inc. of San Francisco, Calif.

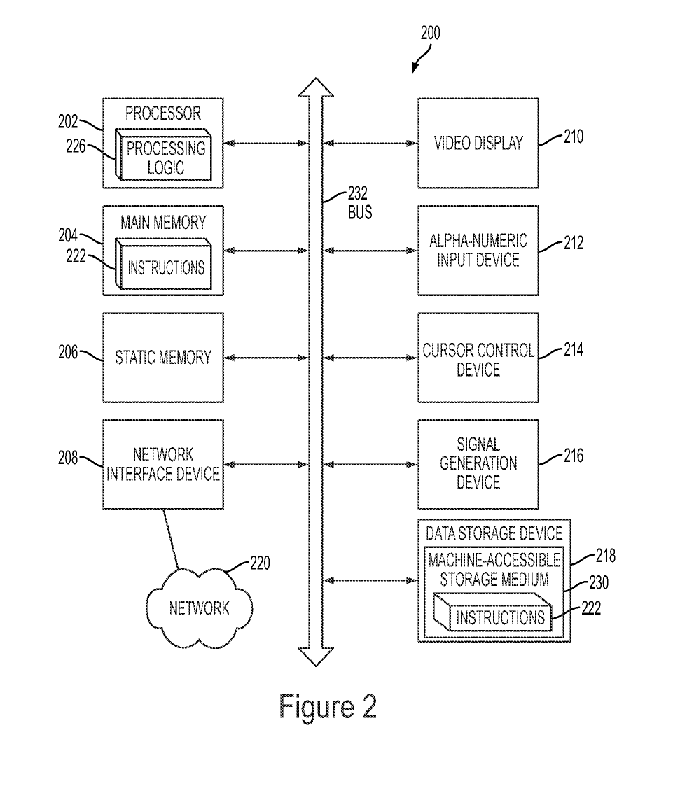

FIG. 2 illustrates a diagrammatic representation of computer 200 that can be used within content management system 5, for example, as client computer, or as content management server 20 (FIG. 1). For purposes of this disclosure, reference to a server or processor, shall be interpreted to include either a single server, a single processor, or multiple servers, or multiple processors.

In particular embodiments, computer 200 may be connected (e.g., networked) to other computers by a LAN, WAN, an intranet, an extranet, and/or the Internet. Computer 200 may operate in the capacity of a server or a client computer in a client-server network environment, or as a peer computer in a peer-to-peer (or distributed) network environment. Computer 200 may be a personal computer (PC), a tablet PC, a mobile device, a web appliance, a server, a network router, a switch or bridge, or any computer capable of executing a set of instructions (sequential or otherwise) that specify actions to be taken by that computer. Further, while only a single computer is illustrated, the term “computer” may also include any collection of computers that individually or jointly execute a set (or multiple sets) of instructions to perform any one or more of the methodologies discussed herein.

Exemplary computer 200 may include processor 202, main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and data storage device 218, which communicate with each other via bus 232.

Processor 202 may represent one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 202 may also be one or more special-purpose processing devices such as an application specific integrated circuit (ASIC), a field programmable gate array (FPGA), a digital signal processor (DSP), a network processor, or the like. Processor 202 may be configured to execute processing logic 226 for performing various operations and steps discussed herein.

Computer 200 may further include a network interface device 208. Computer 200 also may include video display 210 (e.g., a liquid crystal display (LCD) or a cathode ray tube (CRT)), alphanumeric input device 212 (e.g., a keyboard), cursor control device 214 (e.g., a mouse), and signal generation device 216 (e.g., a speaker).

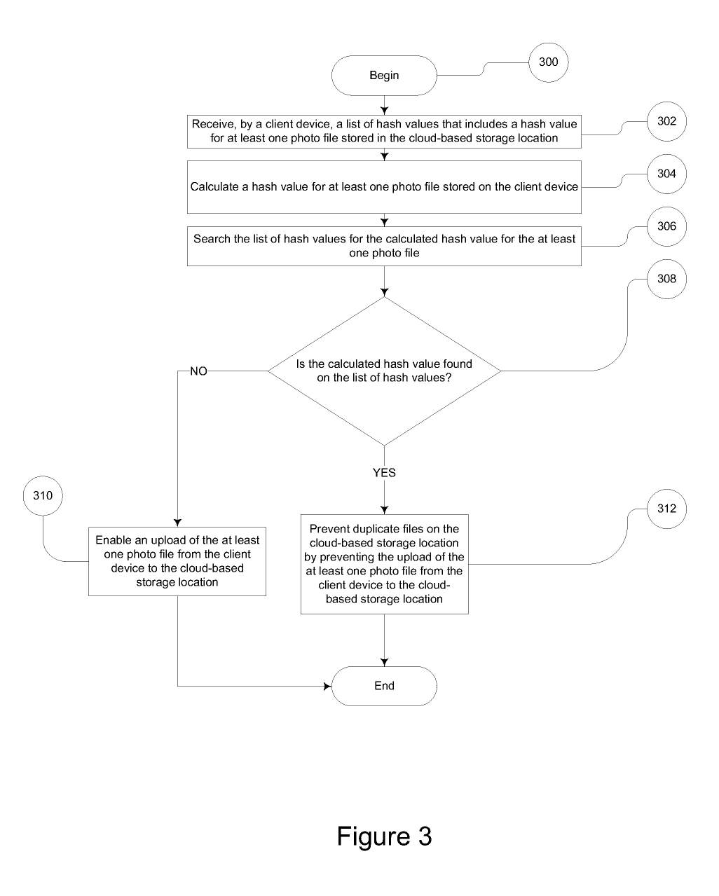

Data storage device 218 may include machine accessible storage medium 230 (also known as a non-transitory computer-accessible storage medium, a non-transitory computer-readable storage medium, or a non-transitory computer-readable medium) on which is stored one or more sets of instructions (e.g., file upload module 27, which is configured to carry out the steps illustrated in FIG. 3) embodying any one or more of the methodologies or functions described herein. File upload module 27 may also reside, completely or at least partially, within main memory 204 and/or within processing device 202 during execution thereof by computer 200, main memory 204, and processing device 202 also constituting computer-accessible storage media. Instructions 222 (e.g., file upload module 27) may further be transmitted or received over network 220 via network interface device 208.

While machine-accessible storage medium 230 is shown in an exemplary embodiment to be a single medium, the term “machine-accessible storage medium” should be understood to include a single medium or multiple media (e.g., a centralized or distributed database, and/or associated caches and servers) that store the one or more sets of instructions. The term “machine-accessible storage medium” shall also be understood to include any medium that is capable of storing, encoding, or carrying a set of instructions for execution by the computer and that cause the computer to perform any one or more of the methodologies of the present invention. The term “computer-accessible storage medium” shall accordingly be understood to include, but not be limited to, solid-state memories, optical, and magnetic media.

### Exemplary System Operation

FIG. 3 shows method steps that are embodied by an exemplary file upload module 27, in accordance with various embodiments, which may prevent duplicate files from being uploaded to content management server 20. It should be understood that the content management system may be a content synchronization system or a synchronized file sharing system.

The method starts at step 300 and at step 302, client device 10 may receive hash value list 26 from content management server 20. The hash value list may include hash value(s) for at least one photo file that is stored in a cloud-based storage location, which is associated with an account that is linked to the client device. There are a number of different ways to create a hash value or some similar file identification that is unique to the file. The hash value can be produced by an algorithm, which may be based on one or more attributes of a photo and/or a portion of the photo file. In other embodiments, the hash value may be based on information associated with the photo.

For purposes of this disclosure, the “mobile hash value” is a hash value that is calculated on a mobile device and may be based on at least one attribute of a photo (e.g., the size or name of the photo file) and at least a portion of the data that forms the file. For example, in various embodiments, a mobile hash value may be calculated using a hash algorithm based on a size of the photo file and the data contained in the first 8 kilobytes of the photo file. In other embodiments, the mobile hash value may be calculated based on the name of the photo file and at least a portion of the data that forms the file. Additionally, the algorithm can be a message digest checksum algorithm, such as the MD family of hash functions (e.g., MD5). Furthermore, for purposes of this disclosure; a “standard hash value” is a hash value that is calculated based on all of the bytes that form the photo file.

In various embodiments, each hash value may be unique to a particular file associated with the account on the cloud-based storage system. The hash value(s) (e.g., both the mobile and standard hash values) for each file associated with the account may be stored in hash value list 26, which may be maintained by content management server 20. In some embodiments, hash value list 26 may contain both a mobile hash value and a standard hash value for each file associated with an account on the content management system. Having multiple hash values associated with each file may allow the content management system to maintain a single hash value list for each account that can be used by all types of client devices (e.g., handheld mobile and desktop clients) linked to the account.

At step 304, client device 10 may calculate a hash value for a photo file stored on the client device. In various embodiments, the client device may calculate a hash value for each photo to be uploaded to the cloud-based storage system. As discussed above, a mobile hash value may be calculated on a mobile device. Alternatively, a standard hash value may be calculated on a desktop device.

At step 306, client device 10 may compare the calculated hash value against the hash values contained in hash value list 26. At step 308, client device 10 may determine whether the calculated hash value for the photo file is contained in the hash value list. If the hash value for the photo file matches a hash value in hash value list 26, at step 312, client device 10 may prevent the photo from being uploaded to the content management server. If, on the other hand, the hash value for the photo file does not match a hash value in received hash value list 26, client device 10 may enable an upload of the photo file to the cloud-based storage location associated with the account linked to the client device.

In various embodiments, client device 10 may transfer, to content management server 20, the calculated hash value and instructions to include the calculated hash value in hash value list 26 associated with the account linked to the client device. In other embodiments, client device 10 may update hash value list 26 and upload the updated hash value list to content management server 20. In still other embodiments, content management server 20 may calculate a hash value for the newly uploaded file and update hash value list 26 to include both the hash value calculated by the client device and the hash value calculated by the content management server.

When a mobile hash value is uploaded with a file, the system may, in various embodiments, calculate a full hash value for the uploaded file so that the hash value list may be used by both mobile client devices and desktop client devices. For example, when client device 10 is a mobile device and the file upload is based on a mobile hash value, content management server 20 may calculate a standard hash value to verify that the uploaded file is not a duplicate of a previously uploaded file. The standard hash value check may be especially advantageous since, in various embodiments, the system may need a standard hash value in hash value list 26 for each file uploaded by a mobile handheld client device to allow other non-mobile type client devices to search the hash value list for files that have previously been uploaded by a mobile handheld type client device. In these embodiments, if the standard hash value calculated by content management server 20 matches a standard hash value contained in hash value list 26, even though the mobile hash value did not match a mobile hash value in the list, content management server 20 may reject the upload photo file, from the mobile handheld client device 10, as a duplicate file. It should be understood with reference to the above disclosure that mobile devices calculate a different hash value (e.g., a mobile hash value) to save power, processor bandwidth and to prevent the unnecessary use of data on the user's cell phone plan by uploading duplicate files.

In various embodiments, the content management system may be a synchronized content management system. One example of a suitable synchronized content management system is the Dropbox™ content management services provided by Dropbox, Inc. of San Francisco, Calif.

### CONCLUSION

Having the benefit of the teachings presented in the foregoing descriptions and associated drawings, one of skill in the art will recognize many modifications and other embodiments of the invention. In light of the above, it is to be understood that the invention is not to be limited to the specific embodiments disclosed and that modifications and other embodiments are intended to be included within the scope of the appended claims. For example, although many of the examples described above in the context of preventing the uploading and/or storage of duplicate photo files, the same or similar techniques may be used to prevent the uploading and/or storage of duplicate files of other types (e.g., document files, music files, video files, and .pdf files). Although specific terms are employed herein, they are used in a generic and descriptive sense only and not for the purposes of limitation.

What is claimed is:

1. A computer-implemented method of preventing duplicate files in an account on a cloud-based storage location comprising:
receiving, by a processor on a mobile device, a hash value list, which includes a hash value for at least one photo file stored in the cloud-based storage location;
calculating by a processor on the client device, a hash value for at least one photo file stored on the client device;
searching the received hash value list for the calculated hash value; and
performing a step selected from the group consisting of:
initiating an upload of the at least one photo file from the client device to the cloud-based storage location if the calculated hash value for the at least one photo file is not found in the received hash value list; and
preventing an upload of the at least one photo file if the calculated hash value for the at least one photo file is found in the received hash value list.

2. The computer-implemented method of claim 1, wherein the hash value is calculated using a MD5 checksum algorithm.

3. The computer-implemented method of claim 2, wherein the client device is a mobile device.

4. The computer-implemented method of claim 1, wherein the hash value list includes a first hash value corresponding to a first file received from a first client device configured to run a first operating system and a second hash value corresponding to a second file received from a second client device configured to run a second operating system.

5. The computer-implemented method of claim 1 wherein the at least one photo file has data expressed in bytes, and wherein the hash value is calculated based on at least one attribute associated with the at least one photo file and at least a portion of the data of the at least one photo file.

6. The computer-implemented method of claim 5, wherein the attribute of the at least one photo file is a size of the at least one photo file and the at least a portion of the data of the at least one photo file is the first 8 kilobytes of the at least one photo file.

7. The computer-implemented method of claim 6, wherein a MD5 checksum algorithm is used to calculate the hash value.

8. The computer-implemented method of claim 1, wherein enabling the upload of the at least one photo file from the client device further comprises uploading the at least one photo file and the hash value to a content management server associated with the cloud-based storage location.

9. The computer-implemented method of claim 1, wherein the hash value list is received from a content management server.

10. The computer-implemented method of claim 9, wherein the content management server is part of a synchronized content management service.

11. A system for preventing duplicate files in an account on a content management system that is linked to a client device, the system comprising:
at least one processor operatively coupled to a network connection;
memory operatively coupled to the at least one processor, said memory storing at least one photo file; and
wherein the at least one processor is configured to:
receive a file containing a hash value list for at least one file stored in the account on the content management system;
calculate a hash value for each file stored in the memory;
determine if the calculated hash value for the at least one file is included in the received file containing the hash value list; and
initiate an upload to the content management system, over the network connection, of the at least one file if the calculated hash value for the at least one file is not included in the hash value list.

12. The system of claim 11, wherein the network connection is a wireless connection.

13. The system of claim 11, wherein the at least one file has data expressed in bytes, and wherein the calculated hash value is based on a size of the at least one file and the first 8 kilobytes of the data of the at least one file.

14. The system of claim 11, wherein the client device is a desktop computer.

15. The system of claim 11, wherein the hash value is calculated using an MD5 checksum algorithm.

16. The system of claim 11, wherein the processor is further configured to enable an upload of the hash value for the at least one file so that the content management system can include the hash value in the hash value list.

17. The system of claim 11, wherein the at least one processor is further configured to initiate the upload of the at least one file to a cloud-based storage location associated with the account.

18. The system of claim 11, wherein the cloud-based storage location is a synched file sharing system

19. A system for preventing duplicate files in an account, on a content management system, that is linked to a client device comprising:
means for receiving a file containing a hash value list for a plurality of files stored in a cloud-based storage location, wherein the plurality of files are associated with the account;
a means for calculating a hash value for each file on the client device;
a means for determining whether the calculated hash value for each file is contained in the hash value list; and
a means for enabling an upload of each file where the calculated hash value for the file is not contained in the hash value list.

20. The system of claim 19, wherein each of the plurality of files has data expressed in bytes, and wherein the means for calculating a hash value further comprises a means for calculating a hash value based on an attribute of the file and at least a portion of the data that forms the file.

21. The system of claim 20, wherein the attribute of the file is a size of the file and the portion of the data that forms the file is the first 8 kilobytes of the file.

22. The system of claim 19, wherein the means for determining whether the calculated hash value for each file is contained in the hash list further comprises a means for comparing the calculated hash value to each hash value contained in the hash value list.
